(19) United States
(12) Patent Application Publication
(10) Pub. No.: US 2024/0083328 A1
(43) Pub. Date: Mar. 14, 2024

(54) Unloading System for a Vehicle

(71) Applicant: Jacob Thompson, Riverside, TX (US)

(72) Inventor: Jacob Thompson, Riverside, TX (US)

(21) Appl. No.: 17/941,290

(22) Filed: Sep. 9, 2022

(51) Int. Cl. B60P 1/00; B60P 1/64

(52) U.S. Cl. CPC B60P 1/006; B60P 1/6427

(57) ABSTRACT

A vehicle unloading system provides hauling and unloading capabilities for a load of a vehicle. The system includes a container section having two sidewalls joining separate sides of a front wall. A chassis is configured to support the container section and includes a central support beam extending from the front end to a rear end of the container section and defines a central axis. Crossmembers extend across the width of the chassis and perpendicular to the central support beam. A tension directing mechanism positioned along the rear end of the container section is in tensioned relation with a first tensioning device affixed to the front wall as well as a push plate positioned adjacent the front wall. The tensioned relation between the tension directing mechanism and the first tensioning device and the push plate is defined by a central cable and a pair of outer cables, respectively.

### FIELD OF THE INVENTION

The disclosure relates generally to unloading systems for vehicles, and more specifically to a vehicle system that provides an alternative means to unload a load from a powered or unpowered vehicle.

### BACKGROUND OF THE INVENTION

Trucks and truck trailer attachments provide an efficient means for moving and transporting items. For jobs that require the loading and unloading of messier items, such as trash, vehicles are limited in their ability to easily load and unload all portions of the messy items. Additionally, the systems used to remove trash from a vehicle typically contain many moving parts that must be controlled and monitored by an individual positioned at the rear end of the vehicle, many of which make the unloading process a slow and time-consuming process. The configurations of these systems can become very complicated, and because of that, become very expensive.

For example, trucks (such as trash trucks) can include a hydraulic system used to tilt a rear portion of the truck containing loaded items/trash toward a rear end of the truck, allowing the contents to slide out of the back of the truck. While efficient, this equipment is very costly to produce and therefore adds to the overall costs of load transportation.

Within the art, a need exists for a vehicle system that efficiently transports, stores, and unloads disorganized items from the vehicle while also being easy to manufacture and is low in cost.

### BRIEF SUMMARY OF THE INVENTION

The disclosed subject matter provides an unloading system integrated with an unpowered vehicle that provides hauling and unloading capabilities for a load of the vehicle. The system includes a container section having two sidewalk joining separate sides of a front wall. A chassis is configured to support the container section and includes a central support beam extending from the front wall to a rear end of the container section and defines a central axis. Crossmembers extend across the width of the chassis and perpendicular to the central support beam. A tension directing mechanism positioned along the rear end of the container section is in tensioned relation with a first tensioning device fixed to the front wall as well as a push plate positioned adjacent the front wall. The tensioned relation between the tension directing mechanism and the first tensioning device and the push plate is defined by a central cable and a pair of outer cables, respectively. When the container is loaded, the push plate may rest adjacent the front of the container section until the load is ready to be removed. Once the load is ready to be removed, the first tensioning device is actuated, pulling the push plate from a resting position towards the rear end of the container section and pushing the load out of the back of the container section/vehicle. The first tensioning device may be run via a power source associated with itself or a trailer.

An additional embodiment provides a vehicle bed system (similar to that described above) attached to a truck-type vehicle (powered vehicle). The winch, in this embodiment, may be run via a power source associated with itself and/or the truck-type vehicle.

An additional embodiment provides a second tensioning device affixed to the front wall and in tensioned relation with the push plate. The second tensioning device may be affixed to a surface opposing the attachment points of the first tensioning device so that the second tensioning device may translate the push plate in a direction towards the front of the container section.

### BRIEF DESCRIPTION OF THE DRAWINGS

The disclosed subject matter, objectives, and advantages thereof, will best be understood by reference to the following detailed description of an illustrative embodiment when read in conjunction with the accompanying drawings, wherein:

FIG. 1A displays a top view of an unloading system integrated with a trailer with a push plate in a resting position, as shown and described herein.

FIG. 1B displays a top view of an unloading system integrated with a trailer with a push plate in an extended position, as shown and described herein.

FIG. 2 displays an interior view of an unloading system for a trailer, as shown and described herein.

FIG. 3A displays a frontal view of a push plate 155 of an unloading system 105 for a trailer, as shown and described.

FIG. 3B displays a zoomed-in partial view of a push plate of an unloading system for a trailer, as shown and described herein.

FIG. 4 displays an interior side view of an unloading system for a trailer, as shown and described herein.

FIG. 5 displays a perspective view of a rear end of an unloading system for a trailer in an open configuration, as shown and described herein.

FIG. 6 displays an interior view of an unloading system for a trailer including a push plate, as shown and described herein.

### DETAILED DESCRIPTION

Reference now should be made to the drawings, in which the same reference numbers are used throughout the different figures to designate the same components.

It will be understood that, although the terms first, second, third, etc. may be used herein to describe various elements, these elements should not be limited by these terms. These terms are only used to distinguish one element from another element. Thus, a first element discussed below could be termed a second element without departing from the teachings of the present disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. In one or more embodiments and as used herein, the term “translate” may mean to “move.”

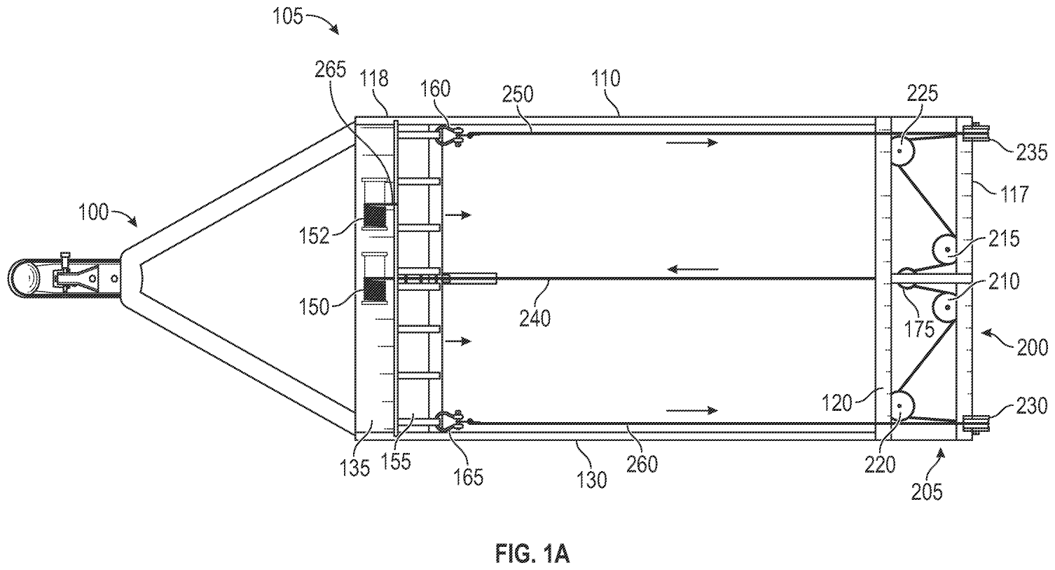

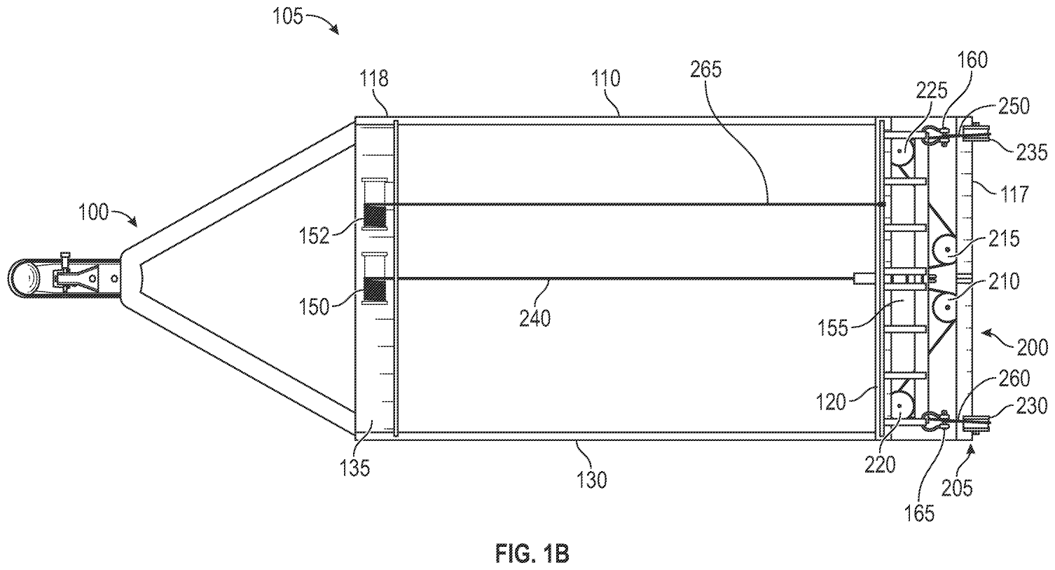

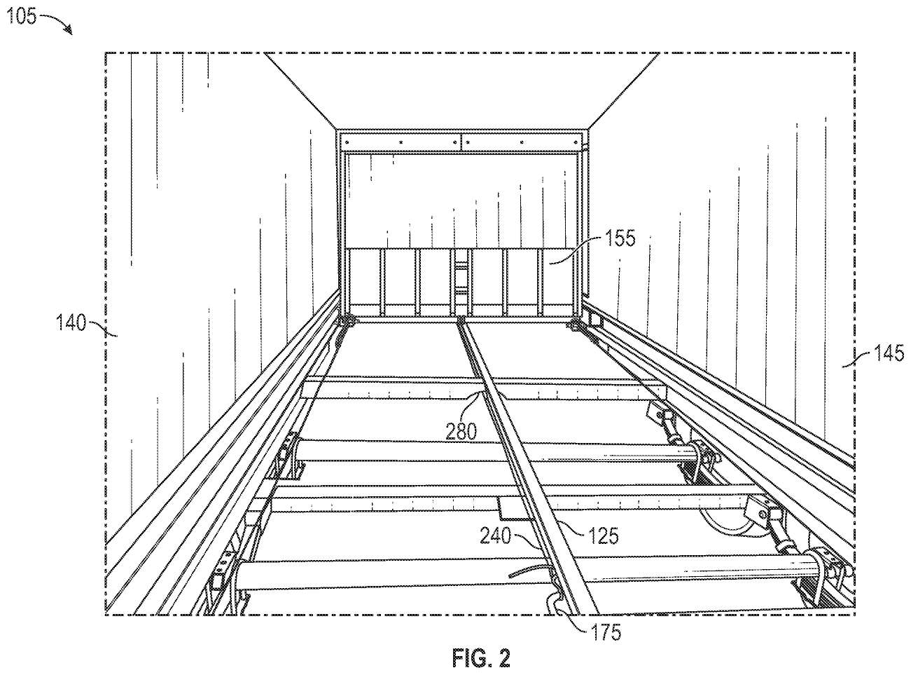

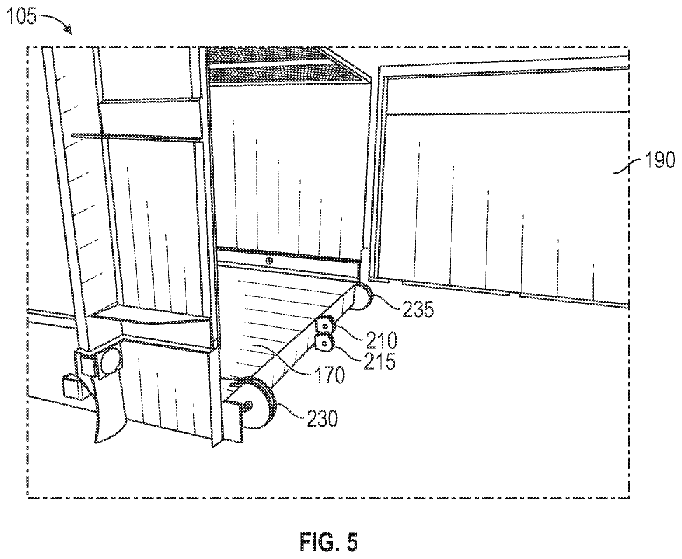

FIG. 1 displays a top view of an unloading system 105 integrated with a trailer 100 having a chassis 110, as shown and described herein. For the purposes of this disclosure and in addition to its common meaning, “trailer” may refer to any unpowered vehicle and/or wheeled platform or container meant to be attached to a vehicle. In one or more embodiments, the trailer 100 can be a rear receiver hitch, front mount hitch, fifth-wheel hitch, gooseneck hitch, pintle hitch, bumper hitch, and/or a weight distribution hitch. As shown, a floor 170 (see FIG. 5) and a plurality of crossmembers 120 sans a rear crossmember 120 is removed to provide a view of the chassis 110 of unloading system 105. Unloading system 105, (typically when floor 170 is installed in trailer 100 or on a trailer pulled by a vehicle) may provide hauling and unloading capabilities for a load. System 105 may include a container section 130 having a first and second sidewall 140,145 meeting a front wall 135 at separate (side) ends of front wall 135. A chassis 110 configured to support the container section 130 includes a central support beam 125 (see FIG. 2) extending from a front end 118 (which may or may not be or include front wall 135) to a rear end 117 of container section 130. Central support beam 125 defines a central axis of system 105/container section 130 that is traversed by a plurality of crossmembers 120 (only rear crossmember 120 shown) that span across perimeter 115 from first sidewall 140 to second sidewall 145.

A tension directing mechanism 205 positioned along rear end 117 is in tensioned relation with a first tensioning device 150 (as shown, a winch) positioned at or about front wall 135 as well as with a push plate 155 positioned adjacent front wall 135; this positioning of push plate 155 positioned adjacent front wall 135/front end 118 may be referred to as the push plate's 155 resting position. As shown, the “tensioned relations” or tension force translating means are defined by cables 240,250,260, so tension directing mechanism 205 (plurality of pulleys adjacent rear end 117) is in tensioned relation with first tensioning device 150 via central cable 240 and is further in tensioned relation with push plate 155 via first and second outer cables 250,260. Tension directing mechanism 205, as shown, includes three pairs/sets of pulleys: lower inner pulleys 210,215, lower outer pulleys 220,225, and upper pulleys 230,235. Lower inner pulleys 210,215 may be positioned directly, and symmetrically, adjacent rear end 117 and are each configured to receive first and second outer cables 250,260 in clockwise and counterclockwise configurations, respectively. It is noted that first tensioning device 150, tension directing mechanism 205 and the tension force translating means (including, but not limited to cables 240,250,260) may be collectively referred to as tensioning system 200.

As the first and second outer cables 250,260 extend outward, they are tensioned diagonally by respective lower outer pulleys 220,225 positioned a distance farther from the central axis and a distance closer to front wall 135 in relation to the positioning of lower inner pulleys 210,215 to the central axis and front wall 135. It is noted that the bodies of lower inner pulleys 210,215 and lower outer pulleys 220,225 are positioned parallel to the length of container section 130 (axles perpendicular to floor 170) so that pulleys 210,215,220,225 may properly function while being positioned under a bed of a truck or under a floor of a trailer. After passing through lower outer pulleys 220,225, first and second outer cables 250,260 extend slightly outward and upward to meet upper pulleys 230,235. Upper pulleys may sit on opposite ends of a top surface of rear end 117 and may share a rotational axis that spans the width of perimeter 115. Due to their position, upper pulleys 230,235 may directly feed first and second outer cables 250,260 to a pair of anchor points 160,165 positioned on opposite (side) ends of push plate 155.

The other ends of first and second outer cables 250,260 may be affixed to translatable anchor point 175, the tension forces of which may be balanced via central cable 240 that is attached to an opposite side of translatable anchor point 175 and first tensioning device 150. When first tensioning device 150 is actuated by a power source (not depicted) of a vehicle, trailer 100, or unloading system 105, translatable anchor point 175 is translated along central axis, providing stability to unloading system 105 while push plate 155 is ultimately actuated via the winding and unwinding of central cable 240 (on first tensioning device 150) between a first (resting) position adjacent front wall 135 and a second position, or extended position, adjacent rear end 117, as shown in FIG. 1B. When moved from the first position to the second position, push plate 155 may push a load stored within container section 130 out of rear end 117 of container section 130, ultimately emptying container section 130.

In additional embodiments, the tensioning system 200 can also include a second tensioning device 152 and a retrieving cable 265 extending therefrom. The second tensioning device 152 can be mounted next to the first tensioning device 150 or otherwise mounted about the front end 118 or front wall 135. Retrieving cable 265 can be attached to the push plate 155 such that when the push plate 155 has been moved to the rear of container section 130 via first tensioning device 150 (extended position), the second tensioning device 152 can retract the push plate 155 to the front end 118 via the retrieving cable 265 (retrieving cable 265 is shown retracted in FIG. 1A and extended in FIG. 1B). Specifically, after the first tensioning device 150 is activated and moves the push plate 155 to the rear end 117 via the first and second outer cables 250,260, the second tensioning device 152 can be activated and retrieve the push plate 155 to its resting/starting position at the front (about the front wall 135). Returning the push plate 155 to the front starting position puts the tensioning system 200 in a position to move an additional load out of container section 130.

As shown in FIG. 2, translatable anchor point 175 and the attached central cable 240 extend along the central axis/central support beam 125 while first and second outer cables 250, 260 (FIG. 1) run parallel with the central axis along inner sides of chassis 110/container section 130. In order for central cable 240 and translatable anchor point 175 to move freely along central axis (and below floor 170), central portions of crossmembers 120 may include cavities 280 positioned below central support beam 125 so that central cable 240 and translatable anchor point 175 are not inhibited by any components of unloading system 105.

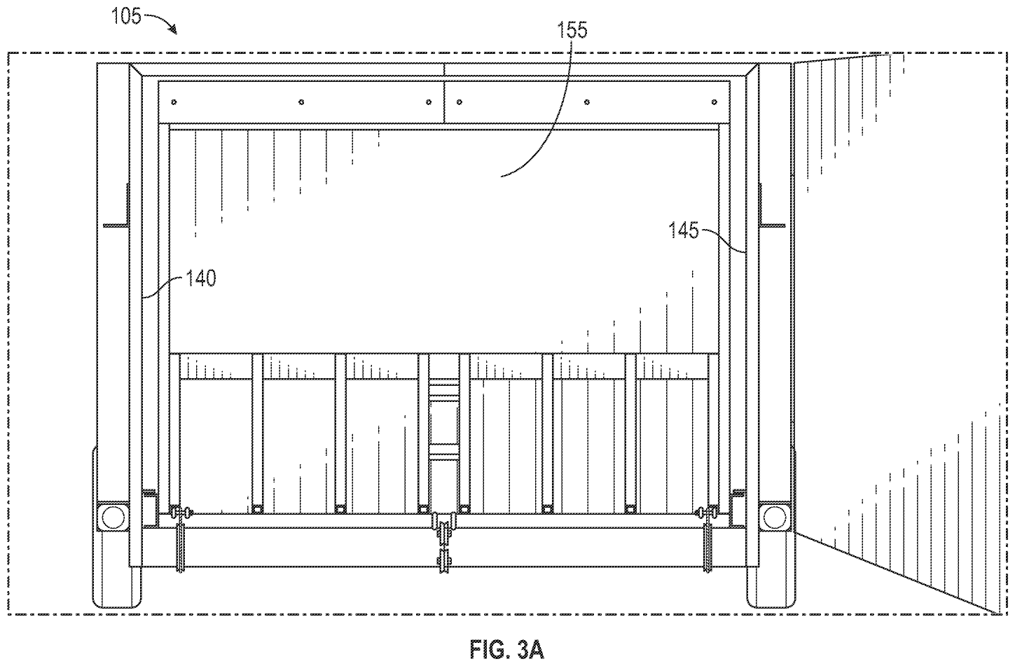

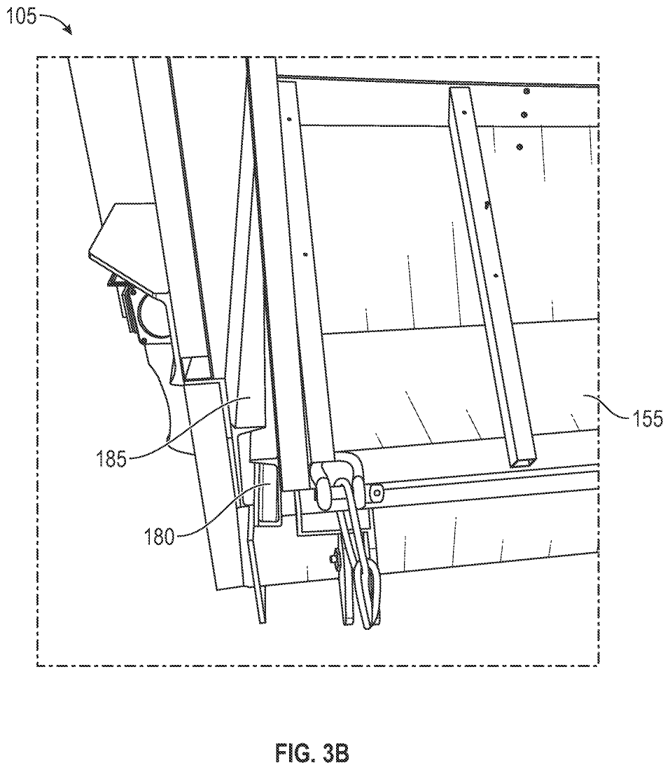

FIG. 3A displays a frontal view of a push plate 155 of an unloading system 105 for a trailer, as shown and described. Push plate 155 is shown positioned between first and second sidewalls 140,145 and when engaged, push plate 155 may translate along the length of first and second sidewalls 140,145 in order to move a load out of trailer 100/unloading system 105. Push plate 155 further includes at least one cable diverter positioned below the first tensioning device 150. Cable diverter may be configured to alter the angle of translation of the central cable 240 when first tensioning device 150 actively winds up central cable 240. In embodiments, cable diverter may comprise one or more pulleys. In other embodiments, cable diverter may include more than one fixed arc structures (not shown) having a friction reduction component. The arcs may be positioned in a line along the width of push plate 155 up toward first tensioning device 150. In this embodiment, central cable 240 may be fed through each of the arcs so that central cable 240 may be diverted from below floor 170 (and running parallel with the length of container section 130) to perpendicular with floor 170 toward first tensioning device 150. In order to reduce friction on central cable 240, a bearing component may be positioned at the apex of each arc so that central cable 240 may smoothly pass through each arc.

FIG. 3B displays a zoomed-in partial view of a push plate 155 of an unloading system 105 for a trailer, as shown and described herein. As shown, outer sides of push plate 155 include inner tracks 180 that may be engaged with an outer track 185 affixed to inner side surfaces of perimeter 115. The tracks 180, 185 may include interacting C-frame portions and may benefit the system by preventing the push plate 155 from wobbling during movement. This may allow for push plate, when actuated, to move along the length of container section 130 while collecting and pushing out a load from a bed of a vehicle by way of sliding and/or rolling. Rolling may include one or more wheeled components affixed to one or both of the track components 180, 185. In embodiments, push plate 155 may move from a position adjacent the front wall 135 to a position adjacent the rear end 117. It is further noted that floor 170 (FIG. 5) may be positioned below push plate 155 and between inner tracks 180 so that push plate 155 may be seamlessly moved from front end 118 to rear end 117.

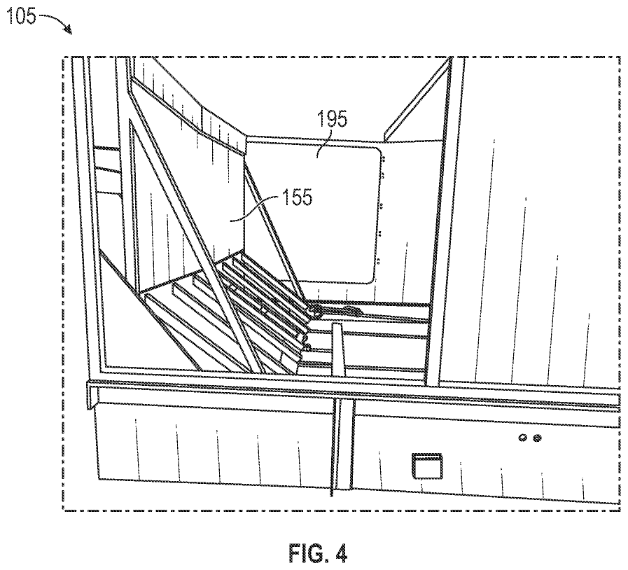

FIG. 4 displays an interior side view of an unloading system 105 for a vehicle, as shown and described herein. As shown, push plate 155 may comprise a height that may extend to a preferable height, including extending from a floor to a roof of a vehicle/trailer/container section 130. This configuration of push plate 155 may be utilized in trailers or vehicles that have a similar build to a container truck (such as a trash truck, a tractor trailer, etc.) and/or in trailers or vehicles that include container section 130 having a load stacked up to the ceiling of container section 130. In addition, a load opening 195 may be positioned within at least one of sidewalls 140,145 so that items making up a load (trash, etc.) may be placed within container section 130.

FIG. 5 displays a perspective view of a rear end 117 of an unloading system 105 for a trailer in an open configuration, as shown and described herein. As shown, an alternative embodiment of the lower inner pulleys 210,215 are positioned outside of container section 130. This embodiment may efficiently deliver first and second outer cables 250,260 to lower outer pulleys 220,225. In order to provide an uninterrupted path for a load of a vehicle to be removed, a swinging door 190 may be utilized (as shown). Floor 170 of container section 230 is shown positioned above tensioning system 200. When utilized to move a load, tensioning system 200 may translate tension force at least partially below floor 170 so that tensioning system 200 does not interfere with the load being acted upon by push plate 155 in container section 130. As shown, portions of first and second outer cables 250,260 that extend from upper pulleys 230,235 to anchor points 160,165 may be positioned above the floor 170. In other embodiments, the entirety of first and second outer cables 250,260 may be positioned under floor 170.

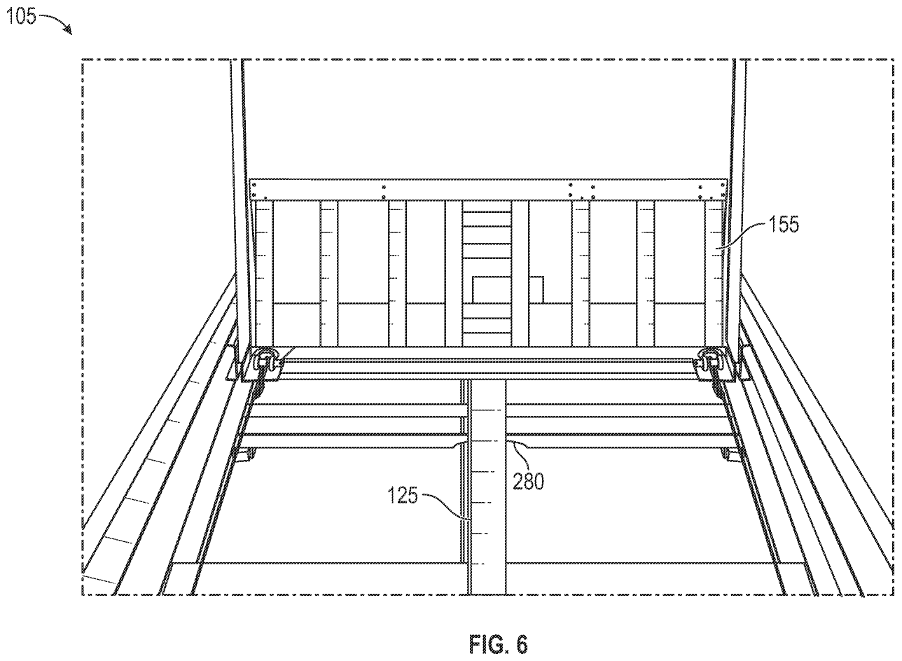

FIG. 6 displays an interior view of an unloading system 105 for a trailer including a push plate 155, as shown and described herein. Push plate 155 is shown positioned between outer tracks 185 of perimeter 115. This positioning may allow push plate 155 to be moved smoothly toward rear end 117 so that a load stored within system 105 may be removed.

It is noted that in embodiments, unloading system 105 may include container section 130, chassis 110, and tensioning system 200. In conjunction, these three elements may work together to store and unload a load from container section 130.

In embodiments, in order for the push plate 155 to return to a stored position, the rear of push plate 155 may be tensionally connected to front wall 135. For example, push plate 155 may be affixed to front wall 135 via at least one of a cable mechanism, a spring mechanism, and a compression mechanism. In embodiments, any of the aforementioned mechanisms may be electrically powered.

For the purposes of this disclosure, the term “vehicle” may be defined as any transportation device that is capable of effectively housing the unloading system 105. For example, “vehicle” may refer to any of the following: non-motor/unpowered vehicles (trailers), motor vehicles (trucks, cars, busses, etc.), railed vehicles (trains, etc.) and watercraft (boats, etc.)

For the purposes of this disclosure, the term “load” may refer to any weighted object(s) stored within the parameters of the unloading system 105 described. In more specific embodiments, the term “load” may refer to an agglomeration of trash.

For the purposes of this disclosure, it is noted that a bed or floor is needed in order for a load to be stored within system 105 (as shown, at least). It is further noted that wherever this “storing” is referenced, it is implied that a floor or bed is present.

In embodiments, various attachment and fitting techniques and equipment (male-female engagement, magnets fastening means, adhesives, welding, bonding, etc.) may be utilized in any of the disclosed embodiments in order for components of the embodiments to properly attach themselves to and/or efficiently position themselves with one another and so that the unloading system 105 can efficiently and/or properly function. As an example, the anchor points 160,165 of unloading system 105 may include ringed bodies that may be threadably fastened to push plate 155, as opposed to anchor points 160,165 welded to push plate 155.

A plurality of additional features and feature refinements are applicable to specific embodiments. These additional features and feature refinements may be used individually or in any combination. It is noted that each of the following features discussed may be, but are not necessary to be, used with any other feature or combination of features of any of the embodiments presented herein.

Unless otherwise defined, all technical and scientific terms used herein have the same meanings as are commonly understood by one of ordinary skill in the art to which this disclosure belongs. Although methods similar or equivalent to those described herein can be used in the practice or testing of the present disclosure, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present disclosure is not limited to what has been particularly shown and described hereinabove. Rather, the scope of the present disclosure is defined by the appended claims and includes both combinations and sub-combinations of the various features described hereinabove as well as variations and modifications thereof, which would occur to persons skilled in the art upon reading the foregoing description.

I claim:

1. A vehicle unloading system for expelling a load, the system comprising:
a container section having a front wall at a front end and first and second sidewalls each affixed to a respective side of the front wall;
a chassis configured to support the container section, the chassis comprising;
a central support beam extending from the front wall to a rear end of the container section, the central support beam defining a central axis of the chassis; and
a plurality of crossmembers extending across the perimeter and perpendicular to the central support beam;
a push plate positioned within the container;
and
a tensioning system configured to move the push plate along a length of the container section when the tensioning system is actuated.

2. The system of claim 1, wherein the push plate is positioned adjacent the front end of the container section when the push plate is in a retracted position and the push plate is positioned adjacent the rear end of the container section when the push plate is in an extended position.

3. The system of claim 1, wherein the tensioning system comprises:
a first tensioning device affixed to the front wall and in tensional relation with the push plate;
a means for moving tension force between the push plate and the first tensioning device; and
a tension directing mechanism positioned adjacent the rear end of the container section, the tension directing mechanism comprising a plurality of pulleys.

4. The system of claim 3, wherein the means for moving tension force between the push plate and the first tensioning device comprises a plurality of cables anchored to at least the tensioning device and the push plate.

5. The system of claim 3, wherein a tensioned relation between the first tensioning device and the tension directing mechanism comprises a central cable and a tensioned relation between the push plate and the tension directing mechanism comprises a pair of outer cables.

6. The system of claim 5, wherein the central cable and the pair of outer cables are in tensioned relation via a moving anchor point movable along the central axis of the chassis.

7. The system of claim 3, wherein the first tensioning device is configured to moving the push plate along the length of the container section in a first direction.

8. The system of claim 7, further comprising a second tensioning device affixed to the front wall, the second tensioning device configured to moving the push plate along the length of the container section in a second direction.

9. The system of claim 5, further comprising at least one cable diverter positioned below the first tensioning device, the at least one cable diverter configured to alter the angle of translation of the tension carried by the central cable.

10. The system of claim 5, wherein input to the first tensioning device causes translation of the central cable toward the front wall and translation of the push plate toward the rear end of the container section.

11. The system of claim 5, wherein input to the first tensioning device causes a translation of the push plate in a direction opposite a translation of the central cable.

12. The system of claim 1, wherein first and second ends of the push plate comprise an inner track translatably engaged with an outer track affixed to inner side surfaces of the chassis.

13. The system of claim 3, wherein a majority of the plurality of pulleys are positioned below a floor of the container section.

14. The system of claim 1, wherein the tensioning system is configured to move an applied force of the first tensioning device along the central axis to the rear end of the container section and back to the push plate.

15. The system of claim 4, wherein at least a portion of at least one of the plurality of cables are translatable from a position below a floor of the container section to a position above the floor of the container section.
